(19) United States
(12) Patent Application Publication
(10) Pub. No.: US 2007/0097493 A1
(43) Pub. Date: May 3, 2007

(54) IMAGE RECORDING DEVICE FOR MICROSCOPY APPLICATIONS

(75) Inventor: Frank Sieckmann, Bochum (DE)

Correspondence Address: DARBY & DARBY P.C., P. O. BOX 5257, NEW YORK, NY, 10150-5257, US

(73) Assignee: Leica Microsystems CMS GmbH, Wetzlar (DE)

(21) Appl. No.: 11/535,861

(22) Filed: Sep. 27, 2006

(30) Foreign Application Priority Data
Sep. 28, 2005 (DE) 10 2005 046 241.3

(51) Int. Cl. G02B 21/00

(52) U.S. Cl. 359/368; 359/363

(57) ABSTRACT

Disclosed is an image acquisition unit (1) for microscopic applications, including at least one microscope objective (7) which is mounted on a housing. The housing (9) is formed by a plurality of individual separate modules, said plurality of modules including at least an electronic module (2), a camera module (4), an illumination module (6), a focusing module (8), and a filter module (10).

The present invention relates to an image acquisition unit for microscopic applications. In particular, the present invention relates to an image acquisition unit for microscopic applications, including at least one microscope objective which is mounted an a housing.

German Laid-Open Application DE 196 09 288 A1 discloses a compact microscope, especially for routine medical applications. The microscope takes form of a closed housing into which the preparation to be examined is drawn in through an insertion opening. All optical components are mounted within the housing. Alternatively, the microscope is insertable into the standard bay of a computer. All movable components of the microscope are motor-driven and software-controlled by the computer. The preparation can be moved inside tile microscope in two mutually perpendicular directions for selecting the sample details of interest. When the preparation is drawn in, a line sensor generates an overview image of the preparation.

US Patent Application No. 2003/0011883 A1 discloses a microscope system. The microscope system includes a stage which is movable in x and y coordinate directions. Also provided is a lens turret which has formed therein a plurality of openings for receiving an objective lens. Moreover, a TV camera having a CCD chip is mounted on the stand of the microscope. The microscope system is additionally provided with a monitor and a control device. The control device controls the electrically driven stage. The position of the stage can be detected by linear encoders. Using a mouse, the user can input a desired position to which the stage will then be moved correspondingly.

The known methods used in classical microscopy include the incident light method, transmitted light method, fluorescent light method, phase contrast method, interference contrast method, etc. In the prior art, there are microscopes of different size and design, which are used for different applications. A large number of microscopes are used in different fields of industry. Here, the microscopes are used in quality and process control. Microscopes cannot be used in all processes because of their size and particular design. Furthermore, the microscopes are often sensitive to dusts, gases, liquids, etc., so that these microscopes often have to be used outside the processes to be monitored. Thus, the objects to be examined have to be removed from the process and taken to a different location for examination. Therefore, examination of toxic substances is generally very complex to accomplish. The processes carried out in extremely clean rooms are very difficult to examine, because microscopes have many exterior surfaces and edges, which act as a dirt trap and therefore constitute a source of contamination for the extremely clean rooms. It is also very problematic to monitor a process at a multiple points. When using individual microscopes, it is difficult to perform process-accompanying automatic documentation. Moreover, performing process control in response to the analysis results of an object examination by the microscopes is only possible with increased effort.

German Patent Applications DE 102 46 277 A1 and DE 102 46 275 A1 disclose a microscope the stand of which consists of a minimum number of shell parts. In addition, the stand of the microscope is provided with only a focus adjusting knob. Moreover, the microscope is narrow relative to the height of the stand, and the number of control elements is reduced to a minimum. Nevertheless, the microscope has a plurality of exterior surfaces, so that there, is still a risk of dirt accumulations. In addition, its use is limited in various processes because of the microscope stage.

It is an object of the present invention to provide an image acquisition unit for microscopic applications, which is versatile and suitable for different examination conditions. Another object is for the image acquisition Un it to be inexpensive and easy to service and maintain.

This objective is achieved by an image acquisition unit for microscopic applications, having the features of Claim 1.

It is advantageous if the housing is formed by a plurality of individual separate modules, said modules including at least an electronic module, a camera module, an illumination module, a focusing module, and a filter module.

The housing formed by a plurality of modules provides a housing that is rectangular in shape and dust-tight. The housing formed by a plurality of modules is provided with at least one threaded blind hole for attachment of a holder. The housing is provided with at least one connection for power supply and/or data transmission. An electrical connection is provided for power supply to the image acquisition unit. The electrical connection ensures power supply for the entire image acquisition unit. Moreover, an electrical connection is provided for the control of the image acquisition unit and of the image transmission from the image acquisition unit.

The electronic module includes control and analysis electronics. The control and analysis electronics are provided for the camera module, the illumination module and the focusing module.

The camera module includes a digital camera and adaptation optics for adaptation to the filter module. The digital camera is formed by at least one two-dimensional CCD array.

The illumination module includes a light source and adaptation optics for adaptation to the filter module. The light source is a high-power LED, the high-power LEDs being cooled via the housing formed by the plurality of individual modules.

The focusing module includes a focusing mimic and adaptation optics for adaptation to the filter module. The focusing mimic or focusing unit is designed as a mechanical, piezomechanical, electrical or pneumatic unlit, or as an ultrasonic motor the focusing mimic allowing the microscope objective to be moved forward and backward.

The filter module includes a beam splitter cube or a conventional beam splitter. Said beam splitter cube or beam splitter is replaceable. When using the image acquisition unit in fluorescence applications, the beam splitter cube or beam splitter separates the excitation light from the emission light.

At least one exterior surface of the plurality of individual separate modules is formed from a highly thermally conductive material, the blind holes in the at least one exterior surface being likewise provided with a highly thermally conductive holder.

Further advantageous embodiments of the present invention will be apparent from the dependent claims.

The subject matter of the present invention is schematically illustrated in the drawings and will be described below with reference to the Figures, in which:

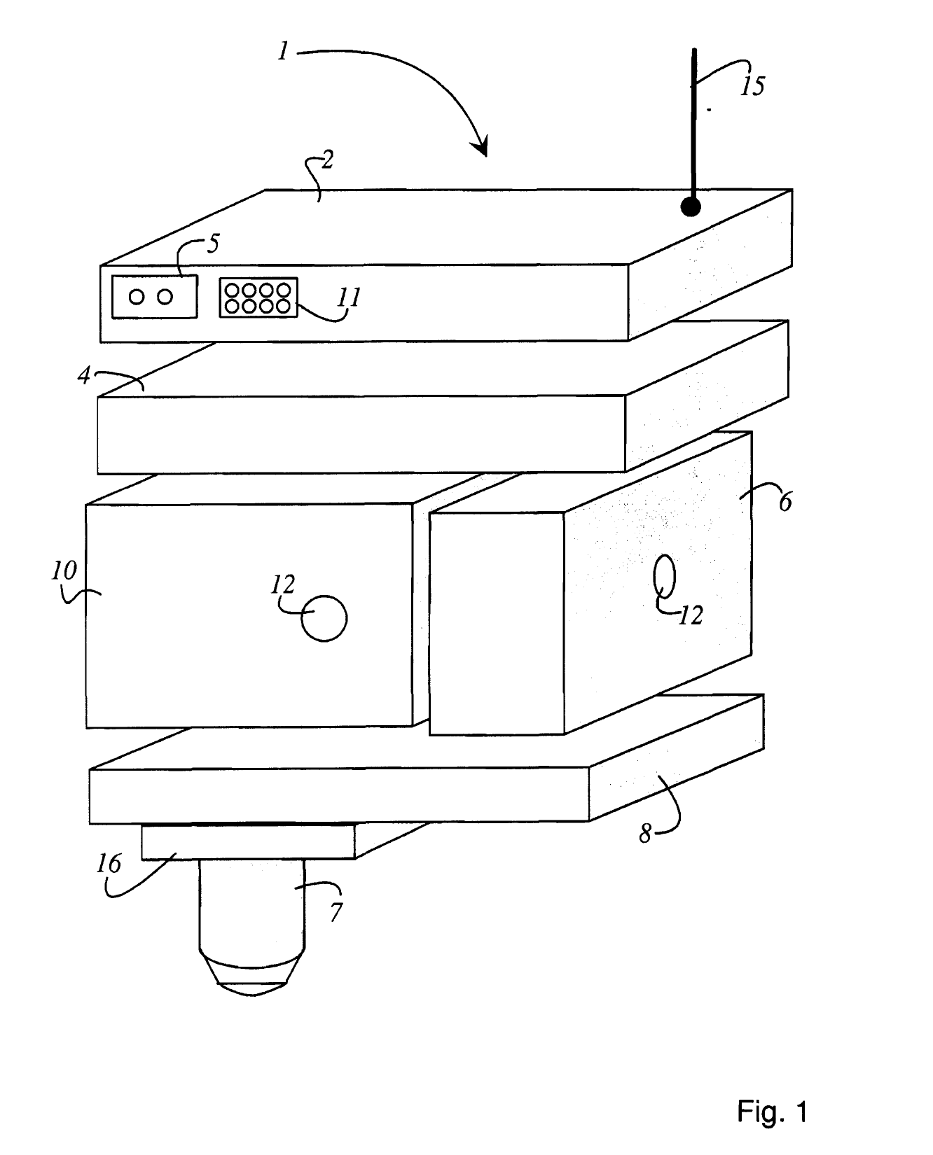

FIG. 1 is a schematic perspective view of the image acquisition unit formed by the plurality of modules;

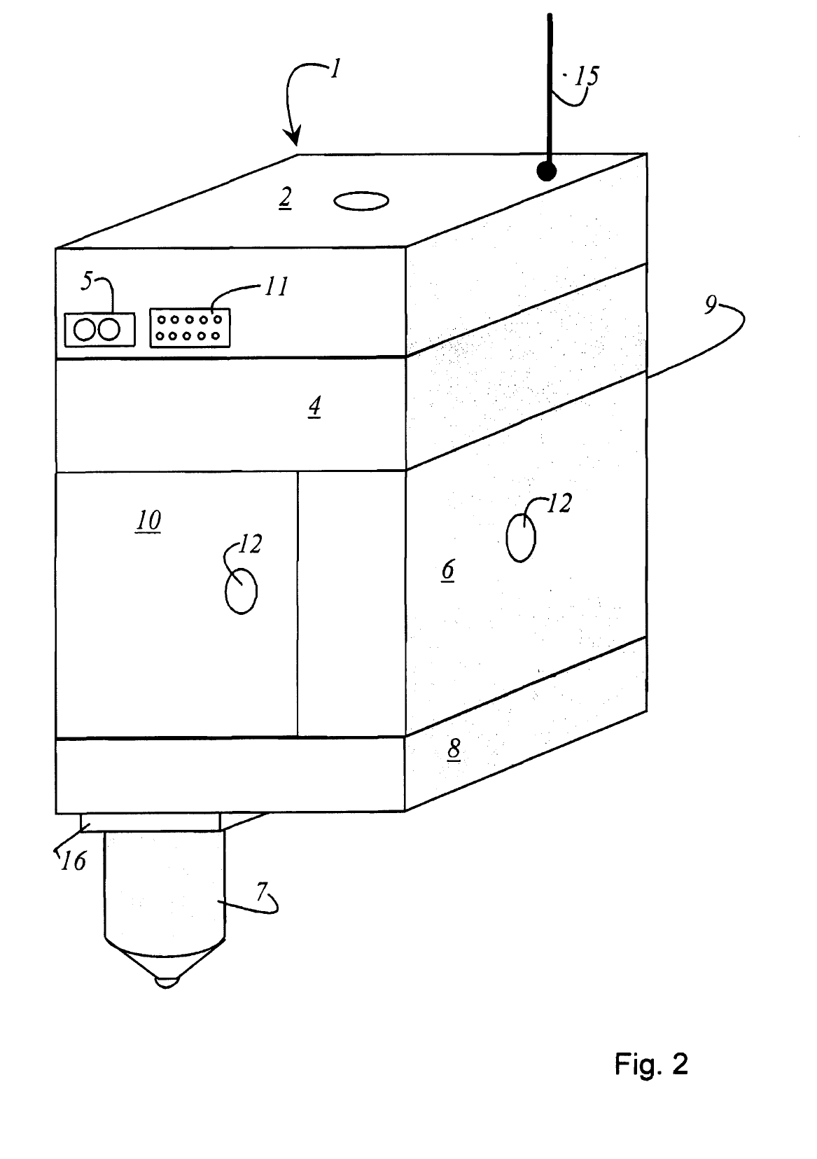

FIG. 2 is a schematic perspective view of the image acquisition unit, the plurality of modules being in the assembled condition, forming a single housing;

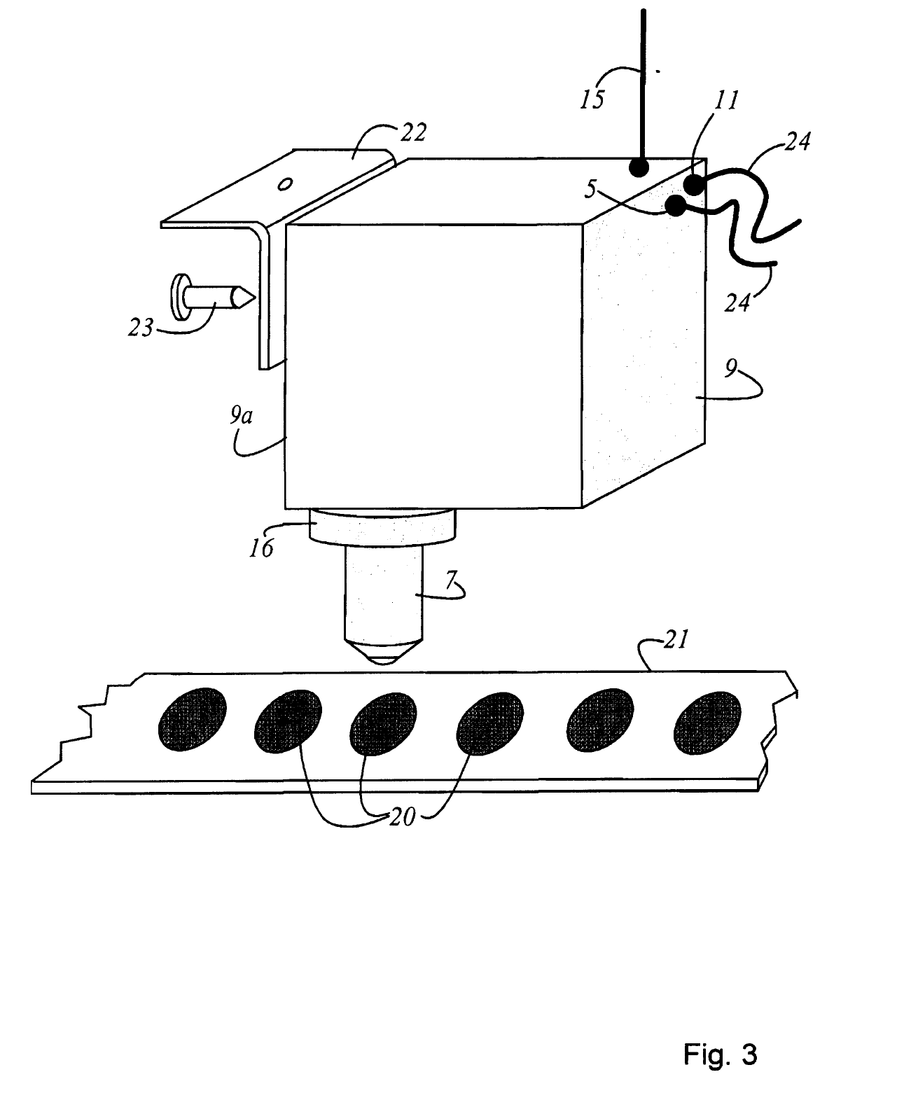

FIG. 3 is a schematic view showing the image acquisition unit in operative position with an object to be examined;

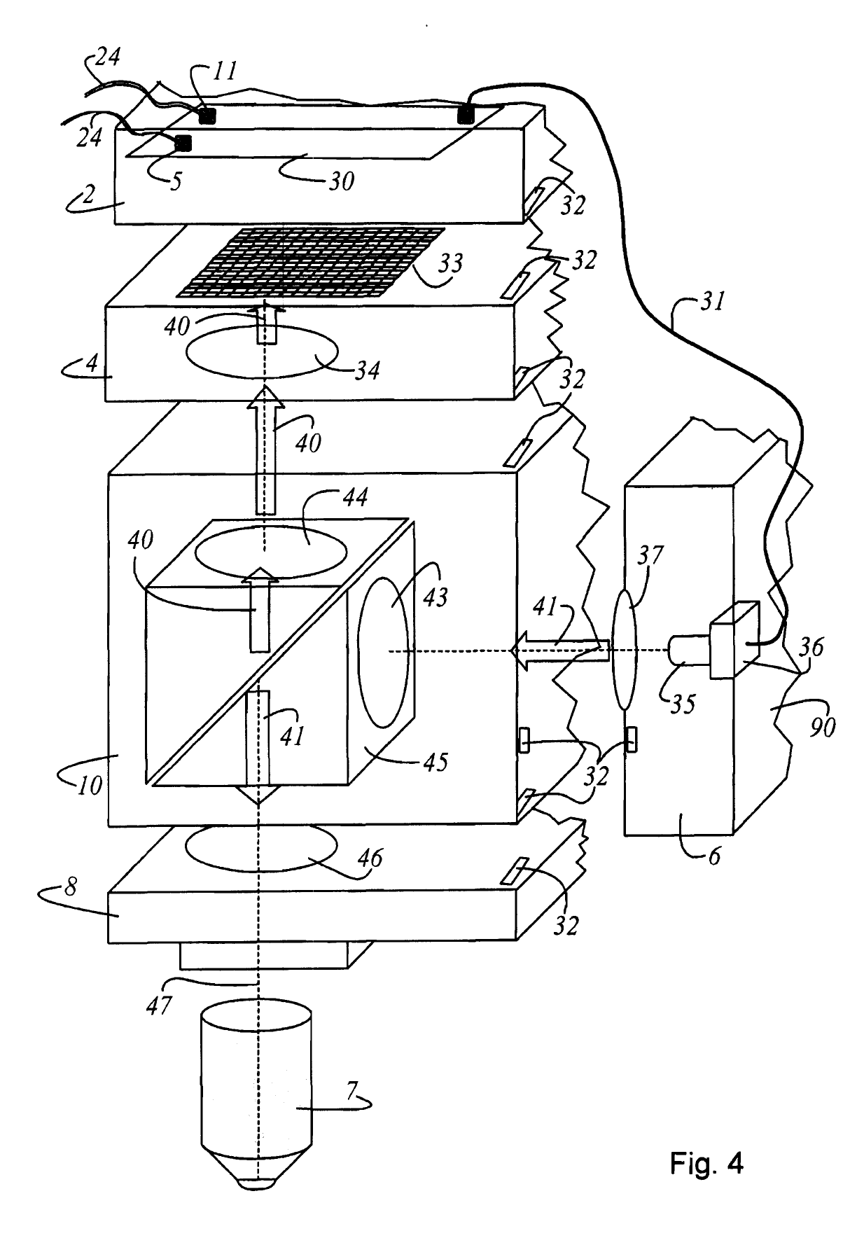

FIG. 4 is a perspective schematic view of the image acquisition unit, illustrating the internal construction of the individual modules; and

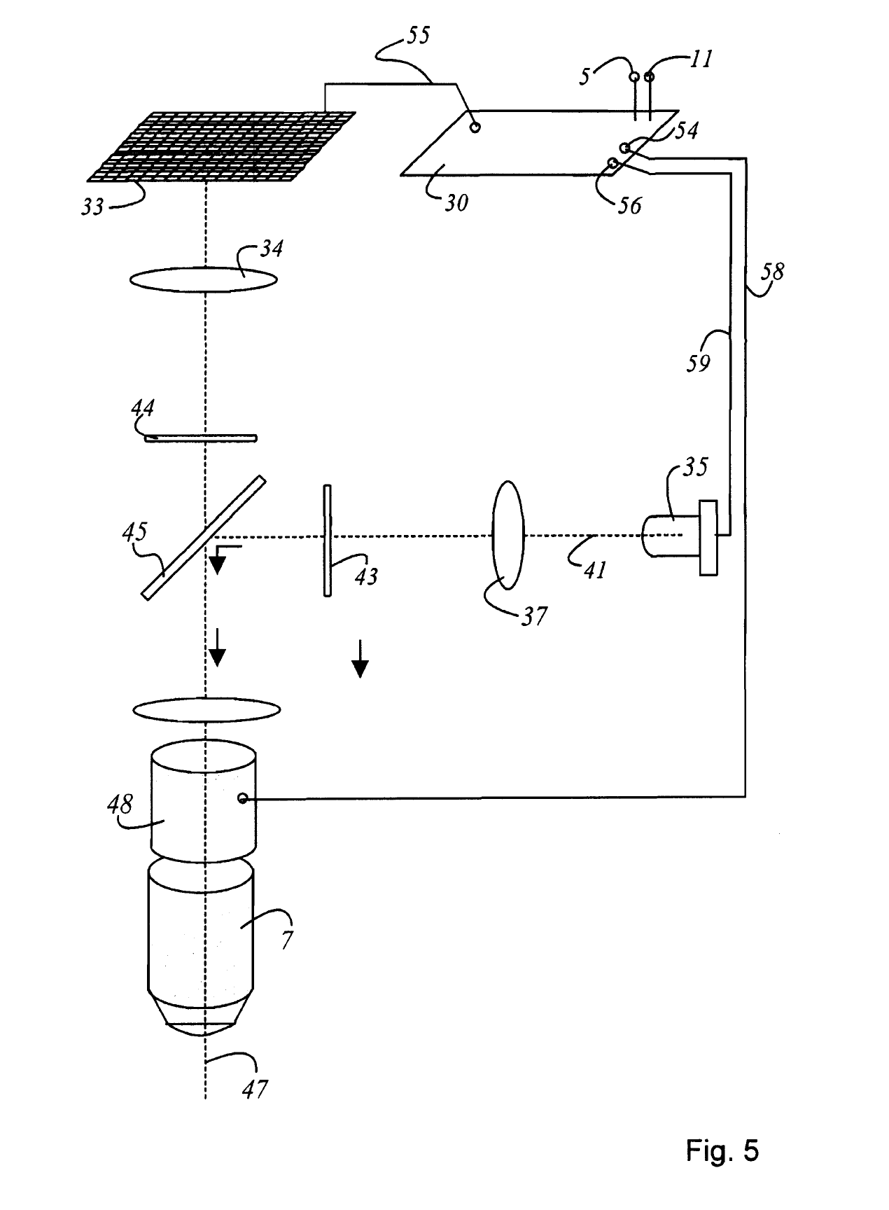

FIG. 5 is a schematic view of the internal construction of the image acquisition unit.

FIG. 1 is a schematic perspective view of image acquisition unit 1, which is formed by the plurality of modules 2, 4, 6, 8 and 10. Housing 9 (see FIG. 2) of image acquisition unit 1 is formed by a plurality of individual separate modules. A first module is an electronic module 2. A second module is a camera module 4. A third module is an illumination module 6. A fourth module is a focusing module 8. A fifth module is a filter module 10. Image acquisition unit 1 further includes at least one objective lens 7. Objective lens 7 is attached to focusing module 8. Illumination module 6 and/or filter module 10 are each provided with a threaded blind hole 12. Blind hole 12 is used for attachment of a holder 13 (see FIG. 3). Electronic module 2 is provided with an electrical connection 5 for power supply to image acquisition unit 1. Image acquisition unit 1 can be supplied with power by a storage battery, by solar cells and/or inductive energy input. Moreover, electronic module 2 is provided with an electrical connection 11 for the control of image acquisition unit 1 and of the image transmission from image acquisition unit 1. Another electrical connection is provided for the control of the image acquisition unit in the form of an antenna 15 for radio transmission. Objective lens 7 or focusing module 8 may additionally be provided with an adjustment wheel 16 which allows objective lens 7 to be moved forward and backward.

FIG. 2 is a schematic perspective view of image acquisition unit 1, the plurality of modules 2, 4, 6, 8 and 10 being in the assembled condition, forming a single housing 9. The mechanical design of the individual modules 2, 4, 6, 8 and 10 makes it possible to achieve dust-tightness.

FIG. 3 is a schematic view showing image acquisition unit 1 in operative position with an object 20 to be examined. In the exemplary embodiment shown, image acquisition unit 1 examines objects 20 which are moved on a conveyor belt 21 past at least one objective lens 7 of image acquisition unit 1. In the process, focusing module 8 (see FIG. 1) focuses objective lens 7 of image acquisition unit 1 sharply onto the objects 20 to be examined, the focusing being accomplished either mechanically or electronically by autofocusing.

Image acquisition unit 1 is attached, via a holding plate 22, to an external holder (not shown) by screw 23 and one of blind holes 12 (see FIG. 1). Power supply to image acquisition unit 1 is via electrical connection 5. The control of image acquisition unit 1 and the image transmission from image acquisition unit 1 is via electrical connection 11. Electrical connection 5 and electrical connection 11 are each connected to a suitable electric line 24. Apart from the fixed physical connection via electric lines 24, it is also possible to provide a radio link via receiving/transmitting antenna 15.

FIG. 4 is a perspective schematic view of image acquisition unit 1, illustrating the internal construction of the individual modules 2, 4, 6, 8 and 10. Electronic module 2 includes at least one control board 30, which is used for controlling camera module 4 (image data and control, such as triggering, frame rate, white balance, shading correction, etc.). Control board 30 includes various microcontrollers, preferably FPGAs, which are responsible for the various control tasks. The control tasks relate, for example, to camera module 4, illumination module 6, focusing module 8, and the self-test, etc.

As disclosed earlier, control board 30 is disposed in electronic module 2 and connected to the other modules 4, 6, 8 and 10 via cable 31 and plug connector 32. Modules 2, 4, 6, 8 and 10 are reversibly interconnected by plug connectors 32.

Camera module 4 contains camera chip 33 which includes, for example, at least one CCD chip. Moreover, camera module 4 is provided with an optical system 34 which, on the one hand, is adapted to filter module 10 and which, on the other hand, suitably directs light flux 40 from object 20 to camera chip 33. There are different types of camera chips 33 that may be used, such as those for high sensitivity or high image acquisition speed. It is then necessary to adapt the electronics in electronic module 2. If the electronics is suitably designed, the adaptation can be done via a firmware update, so that camera module 4 can be replaced individually while all other modules 2, 6, 8 and 10 of image acquisition unit 1 may continue in use.

Illumination module 6 accommodates at least one light source 35, which may be in the form of LEDs. When using LEDs, very high intensity LEDs are used which have a high light output and are located on a cooling plate 36 at the outer wall 90 of illumination module 6. This allows heat to be efficiently dissipated to the outside. Illumination module 6 further accommodates an optical adaptation unit 37, which ensures that the light flux of illumination module 6 is suitably adapted to the illumination requirements of image acquisition unit 1. LED-type light source 35 can easily be pulsed and is therefore well-suited for stroboscopic effects. The time point of image acquisition can be precisely set using suitable trigger signals (shutter effect). Moreover, it is possible to dim the illumination of the LED. High-power LEDs are available for different wavelengths Thus, in cases where image acquisition unit 1 is used in fluorescence analysis, the required excitation wavelength can be provided by a suitably adapted LED or a suitably adapted illumination module.

Filter module 10 contains a beam splitter cube 45 which, in the fluorescence case, is adapted to the desired excitation and emission wavelengths. In the normal case of incident light, beam splitter cube 45 consists only of a beam splitter that directs illuminating light 41 onto object 20 and which directs light 40 emerging or reflected from object 20 to camera module 4. When using image acquisition unit 1 in fluorescence applications, beam splitter cube 45 has associated therewith an excitation filter 42 and an emission filter 44.

Focusing module 8 adapts the light flux to objective lens 7 via a suitable optical system 46. In this connection, focusing module 8 can move objective lens 7 in a direction parallel to its optical axis 47, and thus sharply focus the image of object 20.

Focusing module 8 may further include a mechanical adjusting unit 48, which may be adjusted by turning a screw. An electronically controlled focus is also possible. The focus position may be adjusted, for example, by a piezoelectric element (not shown). In the process, control is performed via electronic module 2 or via ultrasonic motors. Focus analysis can be performed externally using image analysis, or internally in image acquisition unit 1 using suitable and fast electronic methods which, together with a software which is permanently integrated in the camera using EEPROM or similar devices and can be adapted to different applications via a firmware update.

FIG. 5 is a schematic view of the internal construction of image acquisition unit 1, illustrating the optical signal flow in a manner similar to a circuit diagram. Light is directed from light source 35 through optical adaptation unit 37 to beam splitter cube 45. The optical properties of the beam splitter cube 45 may also be provided by a dichroic beam splitter. In the fluorescence case, beam splitter cube 45 may further have associated therewith the excitation filter 43 (in the case of incident light, there is no excitation filter) and emission filter 44.

Light beam 41 is deflected by beam splitter or beam splitter cube 45 toward objective lens 7, whereby it passes through adaptation optics 46. Focusing is done by adjusting unit 48. In the case of non-mechanical focus adjustment, adjusting unit 48 of focusing module 8 is controlled via connection 54 of control board 30. Light 40 emerging or reflected from object 7 passes through beam splitter or beam splitter cube 45 toward camera chip 33 of the digital camera. In fluorescence applications, light 40 passes through emission filter 44. Light 40 is projected through an optical system 34 onto camera chip 33. Camera chip 33 of camera module 4 is connected to control board 30 via an electric line 55. Electric line 55 carries the image signals from camera chip 33 to control board 30. Power supply to image acquisition unit 1 is via electrical connection 5. The control of image acquisition unit 1 and the image transmission from the image acquisition unit is via electrical connection 11, An electric line 58 connects the connection 54 of control board 30 to adjusting unit 48. Connection 56 of control board 30 is connected to light source 35 by an electric line 59.

What is claimed is:

1. An image acquisition unit (1) for microscopic applications, comprising at least one microscope objective (7) which is mounted on a housing,
wherein the housing (9) is formed by a plurality of individual separate modules, said plurality of modules including at least an electronic module (2), a camera module (4), an illumination module (6), a focusing module (8), and a filter module (10).

2. The image acquisition unit (1) as recited in claim 1,
wherein the housing (9) formed by the plurality of modules provides a housing that is rectangular in shape; and
the housing formed by the plurality of modules is dust-tight.

3. The image acquisition unit (1) as recited in claim 1,
wherein the microscope objective (7) is provided with a focusing unit or focusing mimic (16) which allows the microscope objective (7) to be moved forward and backward.

4. The image acquisition unit (1) as recited in one of claims 1 through 3,
wherein the housing (9) formed by the plurality of modules is provided with at least one threaded blind hole (12) for attachment of a holder (22).

5. The image acquisition unit (1) as recited in one of claims 1 through 4,
wherein the housing is provided with at least one connection for power supply and/or data transmission.

6. The image acquisition unit (1) as recited in claim 1,
wherein an electrical connection is provided for power supply.

7. The image acquisition unit (1) as recited in claim 6,
wherein the electrical connection ensures power supply for the entire image acquisition unit (1).

8. The image acquisition unit (1) as recited in claim 6,
wherein an electrical connection is provided for the control of the image acquisition unit (1) and of the image transmission from the image acquisition unit (1).

9. The image acquisition unit (1) as recited in claim 8,
wherein the electrical connection for the control of the image acquisition unit (1) is in the form of an antenna for radio transmission.

10. The image acquisition unit (1) as recited in one of claims 1 through 9,
wherein the electronic module includes control and analysis electronics.

11. The image acquisition unit (1) as recited in claim 10,
wherein the control and analysis electronics are provided for the camera module (4), the illumination module (6) and the focusing module (8).

12. The image acquisition unit (1) as recited in one of claims 1 through 11, wherein the camera module (4) includes a digital camera and adaptation optics (34) for adaptation to the filter module (10).

13. The image acquisition unit (1) as recited in claim 12,
wherein the digital camera includes a camera chip (33) which is formed by an at least two-dimensional CCD array.

14. The image acquisition unit (1) as recited in one of claims 1 through 13,
wherein the illumination module (6) includes a light source (35) and adaptation optics (37) for adaptation to the filter module (10).

15. The image acquisition unit (1) as recited in claim 14,
wherein the light source (35) is a high-power LED; and
cooling is via the housing (9) formed by the plurality of modules.

16. The image acquisition unit (1) as recited in claim 14,
wherein the light source (35) is capable of being pulsed, triggered and/or dimmed.

17. The image acquisition unit (1) as recited in claim 14,
wherein the light source (35) is mounted on a cooling plate (36) at the outer wall (90) of the illumination module (6), the heat generated by the light source (35) being able to be removed from image acquisition unit (1).

18. The image acquisition unit (1) as recited in one of claims 1 through 17,
wherein the focusing module (8) includes a focusing mimic or focusing unit (16) and adaptation optics (47) for adaptation to the filter module (10).

19. The image acquisition unit (1) as recited in claim 18,
wherein the focusing mimic or focusing unit (16) is designed as a mechanical piezomechanical, electronic or pneumatic unit.

20. The image acquisition unit (1) as recited in one of claims 1 through 19,
wherein the filter module (10) includes a beam splitter cube or a conventional beam splitter (45).

21. The image acquisition unit (1) as recited in claim 20,
wherein the beam splitter or beam splitter cube (45) is replaceable.

22. The image acquisition unit (1) as recited in claims 20 and 21,
wherein when using the image acquisition unit (1) in fluorescence applications, the beam splitter cube or beam splitter (45) separates excitation light from emission light.

23. The image acquisition unit (1) as recited in claim 22,
wherein in fluorescence applications, the beam splitter or beam splitter cube (45) has associated therewith an excitation filter (43) and/or an emission filter (44).

24. The image acquisition unit (1) as recited in one of claims 1 through 23,
wherein at least one exterior surface (9a) of the plurality of individual separate modules is formed from a highly thermally conductive material; and
the blind holes (12) of the at least one exterior surface (9a) are likewise provided with a highly thermally conductive holder (22).

25. The image acquisition unit (1) as recited in claim 24,
wherein heat-conducting paste provides a thermal connection between the at least one exterior surface (9a) and the thermally conductive holder (12).
